(19) United States
(12) Patent Application Publication
(10) Pub. No.: US 2026/0350180 A1
(43) Pub. Date: Nov. 5, 2026

(54) DETECTING VULNERABILITIES IN COMPUTER FUNCTIONS UTILIZING GENERATIVE MODEL AGENTS

(71) Applicant: OpenAI OpCo, LLC, San Francisco, CA (US)

(72) Inventors: David Aitel, Miami Beach, FL (US); Akshay Bhat, New York, NY (US); Matthew Knight, San Francisco, CA (US)

(21) Appl. No.: 19/365,022

(22) Filed: Oct. 21, 2025

Related U.S. Application Data
(60) Provisional application No. 63/798,122, filed on May 1, 2025.

(51) Int. Cl. G06F 21/57; G06F 21/53

(52) U.S. Cl. CPC G06F 21/577; G06F 21/53; G06F 2221/034

(57) ABSTRACT

The present disclosure relates to systems, non-transitory computer-readable media, and methods for analyzing vulnerabilities within a computer application. The disclosed systems can retrieve, utilizing a code indexing subroutine, a computer function from a function repository of a computer application. Moreover, the disclosed systems can determine a vulnerability ranking for the computer function based on a call graph. The disclosed systems can generate, utilizing a large language model, a threat model comprising a structured data object defining threat parameters corresponding to the computer application. Additionally, the disclosed systems can generate threat objects based on vulnerability rankings and utilize a large language model to analyze computer functions in conjunction with the threat model, thereby indicating threat data associated with the computer function.

### CROSS-REFERENCE TO RELATED APPLICATIONS

This application claims priority to and the benefit of U.S. Provisional Patent Application No. 63/798,122, filed on May 1, 2025, which is incorporated herein by reference in its entirety.

### BACKGROUND

Despite advancements in automated code analysis, current vulnerability detection systems continue to exhibit significant shortcomings. Although many of these systems can identify basic weaknesses or bugs, they often fail to address deeper issues related to security, flexibility, and efficiency. These shortcomings make it difficult for organizations to rely on such systems for consistent and scalable protection against evolving threats.

As just suggested, some existing systems are insecure. For example, conventional vulnerability detection methods frequently process source code or sensitive project data directly within centralized control environments. This blending of analysis and control functions can increase the risk of data leakage, corruption, or compromise. Furthermore, when machine learning models are applied without safeguards, they may be subject to prompt injection or contamination by adversarial inputs embedded in the codebase. Such weaknesses undermine trust in the results and can inadvertently expose sensitive intellectual property or configuration details.

In addition, some existing systems are inflexible. Traditional tools are often designed for specific programming languages, frameworks, or application types, requiring bespoke rules or parsers to function effectively. This rigidity limits their ability to operate across heterogeneous, polyglot codebases that are increasingly common in modern development. In addition, reliance on brittle static analysis techniques such as hard-coded parsers or abstract syntax trees can cause these systems to misclassify or miss vulnerabilities when applied outside their narrowly defined scope.

On top of being insecure and inflexible, many conventional systems are also computationally inefficient. For instance, some systems repeatedly scan entire repositories, regardless of which functions or files have changed. Such redundant approaches waste processing power and memory, increase costs, and slow down development workflows. In large or rapidly evolving projects, this inefficiency prevents timely identification of meaningful security issues and reduces the scalability of the overall analysis process. Furthermore, some existing systems require compiling code (either fully or partially) before parsing for analysis, further adding to the computational expense.

### SUMMARY

This disclosure describes systems, methods, and non-transitory computer-readable media for applying generative artificial intelligence to improve the security analysis of computer code. In particular, the disclosed systems can retrieve, utilizing a code indexing subroutine, a computer function from a function repository of a computer application. Moreover, the disclosed systems can determine a vulnerability ranking for the computer function based on a call graph. The disclosed systems can generate, utilizing a large language model, a threat model comprising a structured data object defining threat parameters corresponding to the computer application. Additionally, the disclosed systems can generate threat objects based on vulnerability rankings and utilize a large language model to analyze computer functions in conjunction with the threat model, thereby indicating threat data associated with the computer function.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a high-level architecture of a generative artificial intelligence (AI) system in accordance with one or more embodiments.

FIG. 2 illustrates a schematic diagram of an example environment of a function threat detection system in accordance with one or more embodiments.

FIG. 3 illustrates an example overview of a function threat detection system generating a threat object in accordance with one or more embodiments.

FIG. 4 illustrates a function threat detection system importing one or more computer functions in accordance with one or more embodiments.

FIG. 5 illustrates a function threat detection system generating a threat model in accordance with one or more embodiments.

FIG. 6 illustrates a function threat detection system generating a threat object by analyzing a computer function within an isolated container in accordance with one or more embodiments.

FIG. 7 illustrates a function threat detection system validating a threat object utilizing a validation agent in accordance with one or more embodiments.

FIG. 8 illustrates an exemplary graphical user interface in accordance with one or more embodiments.

FIG. 9 illustrates an example series of acts performed by a function threat detection system in accordance with one or more embodiments.

FIG. 10 illustrates a block diagram of an exemplary computing device in accordance with one or more embodiments.

FIG. 11 illustrates an example environment of a networking system having a generative AI system in accordance with one or more embodiments.

### DETAILED DESCRIPTION

This disclosure describes one or more embodiments for a function threat detection system that can detect vulnerabilities in computer code by analyzing computer functions of a computer application using a particular architecture for parsing and comprehension. In practice, coded computer functions often have bugs or flaws that potentially create and/or expose vulnerabilities in a computer application. In one or more cases, the function threat detection system 200 can detect bugs by utilizing pipeline that begins with a code indexing subroutine to identify and/or discover computer functions from a function repository associated with the computer application. Continuing the pipeline, the function threat detection system 200 can generate a call graph that defines relationships between the discovered computer functions and utilize the call graph to determine a vulnerability ranking for a computer function. In particular, the function threat detection system 200 can determine an initial finding indicating the severity or prioritization for additional analysis of the computer function. The function threat detection system can, as a further part of the code analysis pipeline, analyze the computer function with a threat model. In one or more cases, the function threat detection system can generate the threat model utilizing a large language model to determine or define threat parameters of the threat model that correspond to the computer application. The function threat detection system can generate a threat object outlining the vulnerabilities and/or threats to the computer code by analyzing the computer function and the threat model with a large language model. In one or more cases, the threat object can aid in triaging and mitigating bugs associated with the computer function that lead to vulnerabilities.

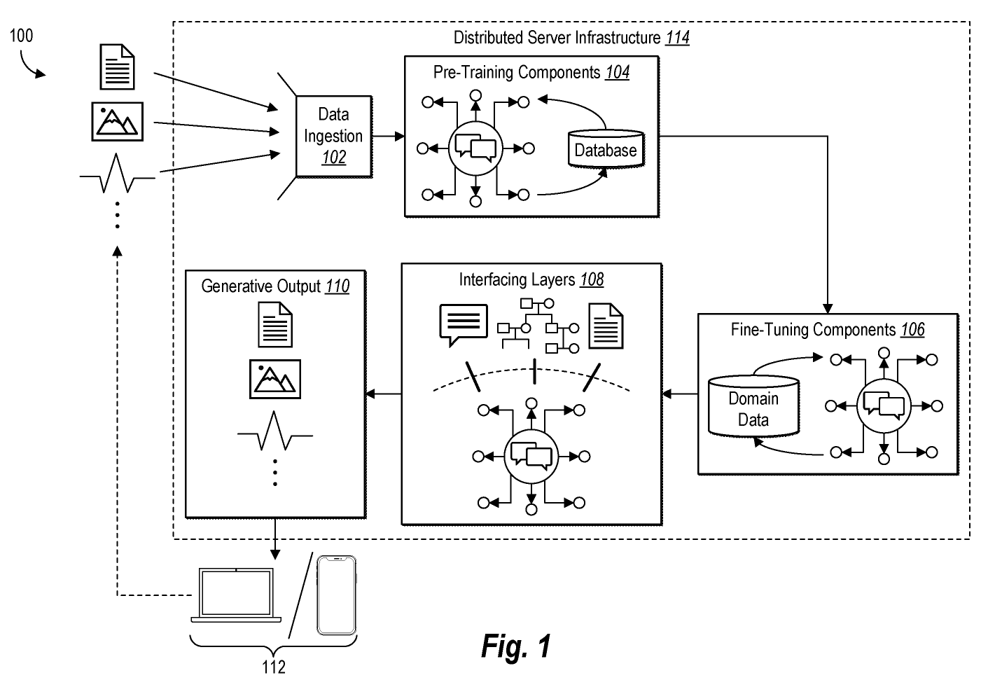

FIG. 1 illustrates a high-level architecture of a generative artificial intelligence (“AI”) system 100 for implementing large language models and other generative models to enable natural language processing, conversational interfaces, multimodal content generation, and analysis in accordance with one or more embodiments. The generative AI system 100 may include data ingestion pipelines 102, pre-training components 104, fine-tuning components 106, interfacing layers 108, and supporting hardware in the form of a distributed server infrastructure 114.

The data ingestion pipelines 102 of the generative AI system 100 may receive and preprocess large volumes of structured and unstructured data, including text corpora, image datasets, video datasets, and audio datasets, to support diverse generative model training. Preprocessing may include deduplication, tokenization, normalization, feature extraction (e.g., spectrogram generation for audio), and content safety filtering, preparing data for effective distributed training across server devices.

The pre-training components 104 of the generative AI system 100 may utilize transformer-based architectures for LLMs, as well as additional generative models such as diffusion models for image generation, autoencoders for representation learning, and multimodal transformer models for cross-domain generation tasks. These models may be configured with deep neural network stacks to capture hierarchical, semantic, and contextual relationships within the data.

The generative AI system 100 may employ diffusion models for image and video generation, where the models learn to iteratively denoise random noise into structured outputs conditioned on textual or other modality inputs. The generative AI system 100 may train these models using score-based or denoising diffusion probabilistic methods across distributed server devices within the distributed server infrastructure 114.

The generative AI system 100 may also implement speech generation models, including text-to-speech (TTS) systems using autoregressive or non-autoregressive architectures, and audio diffusion models capable of generating high-fidelity waveforms conditioned on linguistic and prosodic features. Feature extraction components may preprocess audio data to create Mel-spectrograms or other representations used during model training using the pre-training components 104.

Specialty server devices within the generative AI system 100, such as those of the distributed server infrastructure 114, may include GPUs, TPUs, or custom AI accelerators designed for high-throughput operations supporting both transformer and diffusion model training. These servers may differ from ordinary servers by incorporating high-bandwidth memory (HBM), advanced interconnects (e.g., NVLink, PCIe Gen5), and thermal and power management systems optimized for large-scale generative model workloads.

The generative AI system 100 may store shard-specific checkpoints, intermediate latents, and optimizer states for large-scale diffusion models, LLMs, and multimodal models on high-speed local or network-attached storage within the specialty servers, enabling resumption of training and inference jobs after interruptions or updates.

The fine-tuning components 106 of the generative AI system 100 may adapt generative models to specific user tasks or domain tasks, such as personalized content generation, domain-specific summarization, image style transfer, or voice cloning. Fine-tuning may involve supervised fine-tuning on task-specific datasets and reinforcement learning with human feedback (RLHF), where applicable, with data and gradients distributed across server devices for scalable operation.

The interfacing layers 108 of the generative AI system 100 may handle user prompts for LLM-based text generation, text-to-image generation requests, and speech synthesis requests. The system may tokenize or encode user prompts, generate conditioning latents where applicable (e.g., CLIP embeddings for image generation), and distribute inference tasks across server clusters for each modality-specific generative model. The interfacing layers 108 may include computer scripts, subroutines, or integrated tools for processing prompts, implementing models, and/or performing API calls to supplement and/or augment generative functions of LLMs and other models of the generative AI system 100. In some embodiments, the interfacing layers 108 include databases for accessing stored content (e.g., a vector database of content vectors for comparing with prompt vectors or query vectors) for contextual augmentation of model operation (e.g., for retrieval-augmented generation and its analogs). In some embodiments, the interfacing layers 108 integrate functionality from third-party systems (e.g., external to the generative AI system 100 and/or the distributed server infrastructure 114) into the generative AI system 100 using APIs and/or particular communication protocols to interact with generative model data (e.g., to execute generated code).

As illustrated in FIG. 1, the generative AI system 100 generates generative output 110. The generative AI system 100 can generate the generative output 110 in the form of text responses, images, videos, audio clips, or other multimodal digital content. The generative AI system 100 can generate the generative output 110 using the interfacing layers 108 in conjunction with one or more trained (e.g., pre-trained and fine-tuned, using the described components) generative models, including LLMs and others described herein.

In some embodiments, the generative AI system 100 generates the generative output 110 over one or more conversational interactions or turns with client device(s) 112. Indeed, the generative AI system 100 can provide the generative output 110 for display on the client device(s) 112. In addition, the generative AI system 100 can receive additional input in the form of text-based queries or prompts, images, videos, audio clips, and/or other multimodal content as part of an ongoing conversation between the generative AI system 100 and the client device(s) 112 and/or as part of a new conversation or instantiation of the generative AI system 100.

For large generative models exceeding single-device memory, the generative AI system 100 may implement model parallelism, with different server devices processing partitions of the model during inference across the distributed server infrastructure 114, and may use activation checkpointing and memory recomputation strategies to handle resource constraints efficiently across distributed modalities.

Server devices within the generative AI system 100 may utilize high-bandwidth interconnects for low-latency tensor and latent exchange during multi-stage generation processes (e.g., latent generation followed by decoding in diffusion models). This enables the generative AI system 100 to support complex, multi-step generation tasks, such as generating text and subsequently generating images conditioned on the generated text, while maintaining low latency.

The distributed server infrastructure 114 of the generative AI system 100 may include compute clusters with racks of specialty servers interconnected with high-bandwidth networking technologies such as InfiniBand, RDMA-enabled Ethernet, or custom fabrics, and distributed storage using NVMe over Fabrics (NVMe-oF) for rapid access to large model weights, intermediate outputs, and context data during inference.

The distributed server infrastructure 114 can include safety filtering and content moderation layers that operate in parallel with inference pipelines across modalities, applying token-level filtering for LLM outputs, image or video classification for generated visual content, and audio analysis for speech outputs to ensure outputs comply with operational policies and applicable regulations.

The distributed server infrastructure 114 can include orchestration and resource management layers that dynamically allocate compute, memory, and network resources across modalities, scaling generative model training and inference in response to user demand and system load while monitoring resource health across components of the generative AI system 100.

Collectively, the architecture illustrated in FIG. 1 enables the generative AI system 100 to provide scalable, efficient, and safe generative model services across text, image, video, audio, and other modalities, leveraging specialty server devices and distributed computing for high-throughput training, fine-tuning, and inference across a wide variety of generative AI applications.

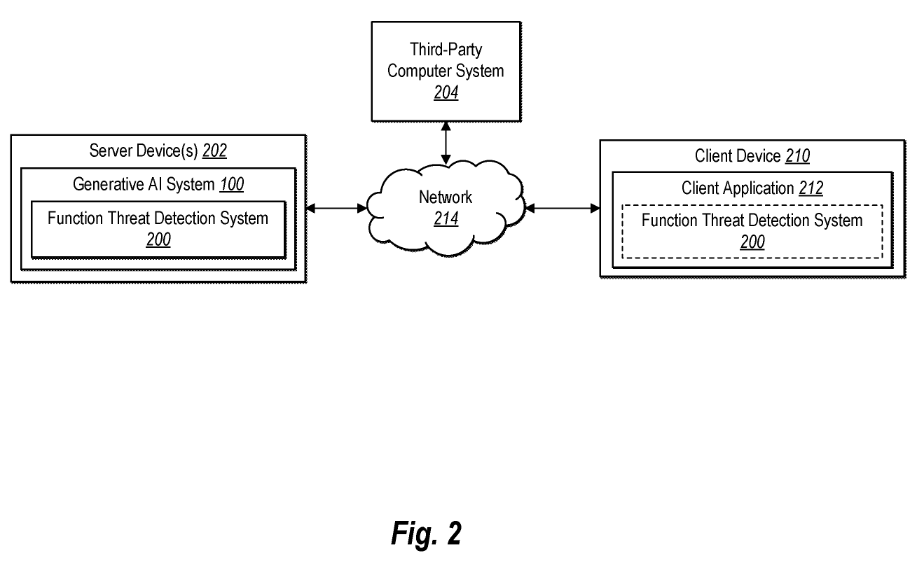

FIG. 2 illustrates a schematic diagram of an example system environment for implementing a function threat detection system in accordance with one or more implementations. An overview of the function threat detection system is described in relation to FIG. 2.

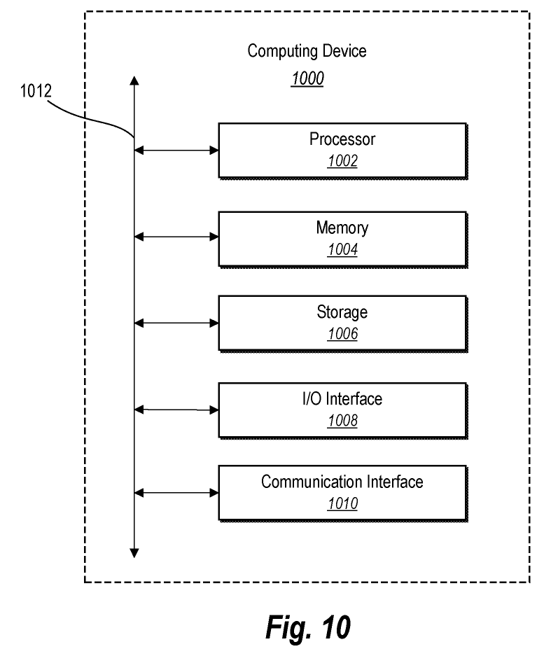

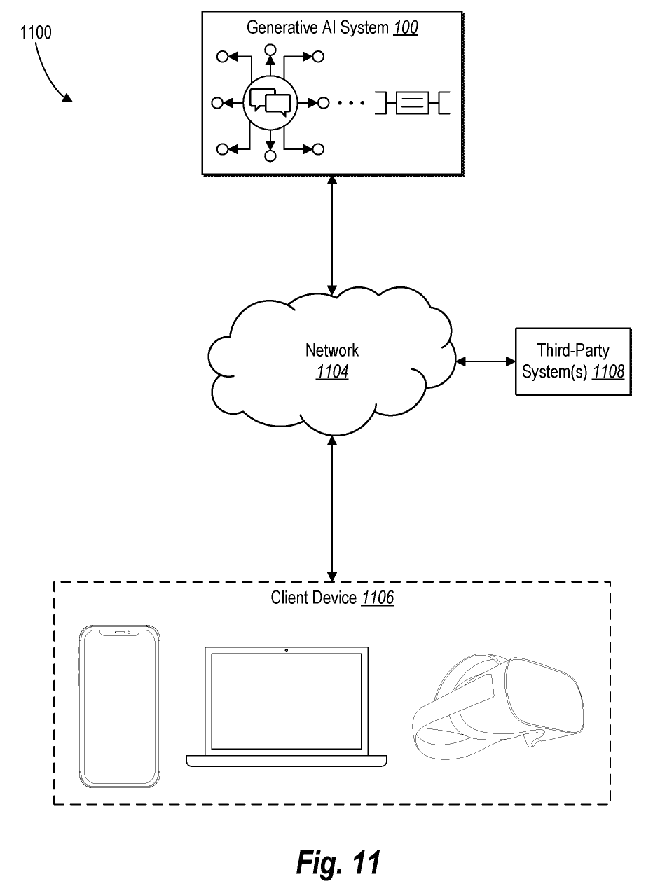

As shown, the environment includes server device(s) 202, a third-party computer system 204, a client device 210, and a network 214. Each of the components of the environment can communicate via the network 214, and the network 214 may be any suitable network over which computing devices can communicate. Example networks are discussed in more detail below in relation to FIGS. 10-11.

As mentioned above, the example environment includes a client device 210. The client device 210 can be one of a variety of computing devices, including a smartphone, a tablet, a smart television, a desktop computer, a laptop computer, a virtual reality device, an augmented reality device, or another computing device as described in relation to FIGS. 10-11. The client device 210 can communicate with the server device(s) 202 via the network 214. For example, the client device 210 can receive user input from a user interacting with the client device 210 (e.g., via the client application 212) to, for instance, interact with a generative AI system 100 located on the server device(s) 202. In addition, the function threat detection system 200 on the server device(s) 202 can receive information relating to various interactions with user interface elements based on the input received by the client device 210.

As shown, the client device 210 can include a client application 212. In particular, the client application 212 may be a web application, a native application installed on the client device 210 (e.g., a mobile application, a desktop application, etc.), or a cloud-based application where all or part of the functionality is performed by the server device(s) 202. Based on instructions from the client application 212, the client device 210 can present or display information, including a threat object, a validated threat object, a dialogue or a thread between a client device associated with a user and a large language model.

As illustrated in FIG. 2, the example environment also includes the server device(s) 202. The server device(s) 202 may generate, track, store, process, receive, search, communicatively link, and transmit electronic data, such as digital content (e.g., content items), datasets, messages, searchable data, pages of data, prompts, user queries, interface elements, external tools, computer functions, threat objects, interactions with interface elements, and/or client devices and the generative AI system 100. For example, the server device(s) 202 may receive data from the client device 210 in the form of a user query or computer functions as part of a code indexing subroutine. Additionally, the device(s) 202 can process inputs through the large language model and return generated outputs such as text, summaries, accessible tools, code, threat objects, threat risk scores, directed graphs, call graphs, and/or annotated call graphs. In some embodiments, the device(s) 202 manage auxiliary tasks such as session tracking, context management, content filtering, and integration with databases or external tools. Indeed, the server device(s) 202 can communicate with the client device 210 to send and/or receive data via the network 214. In some implementations, the server device(s) 202 comprise(s) a distributed server where the server device(s) 202 include(s) a number of server devices distributed across the network 214 and located in different physical locations. The server device(s) 202 can comprise one or more content servers, application servers, communication servers, web-hosting servers, machine learning servers, and other types of servers.

As shown in FIG. 2, the server device(s) 202 can also include the function threat detection system 200 as part of a generative AI system 100. The generative AI system 100 can communicate with the client device 210 to perform various functions associated with the client application 212, such as receiving user queries, scanning a function repository, and/or generating a call graph. In one or more cases, the function threat detection system 200 can perform tasks on a third-party computer system 204 that is connected to the generative AI system 100. The generative AI system 100 ingests structured or unstructured input data from respective data sources and/or codebases and uses the large language model to generate a threat model and intelligently produce outputs, threat objects, and/or recommended actions for addressing vulnerabilities in computer code associated with the third-party computer system 204.

Although FIG. 2 depicts the function threat detection system 200 located on the server device(s) 202, in some implementations, the function threat detection system 200 may be implemented by (e.g., located entirely or in part on) one or more other components of the environment. For example, the function threat detection system 200 may be implemented by the client device 210 and/or a third-party device. For example, the client device 210 can download all or part of the function threat detection system 200 for implementation independent of, or together with, the server device(s) 202. In some embodiments, the function threat detection system 200 is implemented as a plug-in or modular extension associated with the large language model.

As shown in FIG. 2, the example environment also includes a third-party computer system 204. In one or more embodiments, the third-party computer system is external to the device(s) 202 and stores data, computer functions, and/or source code associated with the third-party computer system 204. As shown in FIG. 2, in one or more cases, the third-party computer system 204 can communicate with the server device(s) 202 over the network 214. In one or more embodiments, the third-party computer system 204 can communicate with the generative AI system 100 or the function threat detection system via a connector connecting the third-party computer system 204 to the generative AI system 100.

In some implementations, though not illustrated in FIG. 2, the environment may have a different arrangement of components and/or may have a different number or set of components altogether. For example, the client device 210 may communicate directly with the function threat detection system 200, bypassing the network 214. As another example, the environment can include a database located external to the server device(s) 202 (e.g., in communication via the network 214) or located on the server device(s) 202, on third-party servers, and/or on the client device 210.

As illustrated by the foregoing discussion, the present disclosure utilizes a variety of terms to describe features and benefits of the function threat detection system 200. Additional detail is provided hereafter regarding the meaning of these terms as used in the disclosure. As used herein, the term “computer function” can include or refer to a block of computer code that performs a specific task, operation, and/or function. For example, a computer function can receive an input, process the input, and return a result. In some cases, a computer application can reuse a computer function to perform the corresponding task. In one or more cases, computer functions can interact with each other to perform various tasks. In one or more cases, a computer function may have a unique identifier and/or metadata outlining a purpose, location, dependencies, relationships, parameters, etc., associated with the computer function. In one or more cases, the computer function can correspond to a given programming language, such as, but not limited to: Python, C++, Java, JavaScript, Go, and/or Haskell. Relatedly, as used herein, the term “function repository” can include or refer to an index, collection, and/or list of computer functions. For example, a function repository can include a list of computer functions included in the source code of an application (e.g., a computer application or a web application). In some cases, the function repository can be the source code of the application.

Moreover, as used herein, the term “code indexing subroutine” can include or refer to a computer function discovery and enumeration method. For example, in some implementations, a code indexing subroutine can utilize data parsers, such as, metadata tags (e.g., ctags) and/or large language models, to identify and/or reverse-engineer all computer functions of the source code of a computer application. In one or more cases, the code indexing subroutine is a language-agnostic parsing method. Additionally, the code indexing subroutine can further involve utilizing the data parsers (or metadata tags) and/or the large language models to enumerate the computer functions stored in a function repository. For example, a metadata tag can be a short, machine-readable label attached to a computer function that identifies and/or describes one or more attributes and/or metadata of the computer function.

As used herein, the term “vulnerability ranking” can include or refer to a deterministic or probabilistic scoring process that orders or prioritizes computer functions according to measured or inferred security risk. In one or more cases, the function threat detection system 200 can generate the vulnerability ranking as part of a preliminary vulnerability analysis to identify and/or rank computer functions associated with vulnerabilities based on the vulnerabilities.

Additionally, as used herein, the term “threat model” can include or refer to a model or a data structure that defines security-relevant parameters and analyzes computer functions based on the security-relevant parameters (e.g., vulnerability parameters and/or taint attributes). For example, in one or more cases, the threat model can include a structured data object that defines threat parameters, such as attack surfaces (e.g., APIs), vulnerability classes (e.g., SQL injection), and/or threat prioritization criteria (e.g., weights) associated with a computer function. In one or more cases, the function threat detection system 200 can tailor a threat model based on the program type of the computer function, source code, and/or computer application. In one or more cases, the threat model can be (generated by) a machine-learning model, a neural network, or a large language model. In one or more embodiments, the threat model can be an algorithm or statistical model. Moreover, in some cases, the threat model can be a heuristic or a rule-based model. Additionally, the threat model can provide context about the vulnerabilities of the computer code.

As used herein, the term “threat object” can include or refer to a structured data object generated by a large language model (or a large language model agent) that describes one or more identified security issues associated with a computer function. In one or more embodiments, a threat object codifies the result of analyzing a computer function together with a threat model and can comprise human-readable summaries, machine-actionable evidence references, prioritization metadata, and/or optional validation outputs. A threat object can include an identifier, a short summary of the vulnerability finding, one or more vulnerability class labels, one or more evidence references, a severity (or priority) tag, recommended actions or mitigations, and/or a validation status.

As used herein, the term “generative model” refers to a machine learning model that is configured to generate new data samples that are statistically consistent with the data on which the model was trained. Generative models may include, but are not limited to, large language models, diffusion models, variational autoencoders, generative adversarial networks, and multimodal transformer models. Generative models may be configured to generate outputs across various modalities, including text, images, audio, and video, either independently or conditionally based on input data from the same or a different modality. For example, a generative model may generate an image based on a textual prompt, generate speech based on textual input, or generate text based on prior conversational context, and may operate using probabilistic or iterative denoising methods to produce high-quality, contextually appropriate outputs.

As used herein, the term “large language model” (or “LLM”) refers to a computational model configured to process and generate human-readable text by learning statistical and contextual relationships within natural language data using machine learning techniques. An LLM typically comprises a deep neural network architecture, such as a transformer-based architecture with multiple layers and attention mechanisms, and is trained on large corpora of text using objectives such as masked language modeling, causal language modeling, or autoregressive prediction. The LLM may include billions or trillions of parameters and is capable of performing a variety of language tasks, including but not limited to text generation, summarization, translation, and question answering, by generating outputs based on input prompts in a contextually relevant manner.

Relatedly, the term “machine learning model” refers to a computational construct comprising one or more algorithms and associated parameters that are configured to perform tasks by identifying patterns or relationships within data. A machine learning model may be trained using supervised, unsupervised, semi-supervised, or reinforcement learning techniques, where the model parameters are adjusted based on input data to minimize a loss function or maximize a reward signal. The machine learning model may include, but is not limited to, neural networks (e.g., convolutional neural networks, recurrent neural networks, transformer models), decision trees, support vector machines, or ensemble models, and may be configured to perform tasks such as classification, regression, clustering, anomaly detection, or data generation. A machine learning model may operate on structured, unstructured, or multimodal data and may generate outputs that are used for predictions, decisions, or content generation based on learned representations of input data.

Additionally, the term “neural network” refers to a computational model comprising multiple interconnected processing elements, often referred to as neurons or nodes, that are organized into layers, including an input layer, one or more hidden layers, and an output layer. Each neuron in the neural network applies a transformation, which may include a weighted sum of inputs followed by a non-linear activation function, to produce an output that is transmitted to subsequent neurons in the network. Neural networks are configured to learn representations of data by adjusting the weights and biases of the connections between neurons during a training process that minimizes a loss function. The neural network may include various architectures, including but not limited to feedforward neural networks, convolutional neural networks (CNNs), recurrent neural networks (RNNs), and transformer-based networks (e.g., LLMs), and may be utilized for tasks such as classification, regression, pattern recognition, natural language processing, and generative modeling across structured, unstructured, or multimodal data.

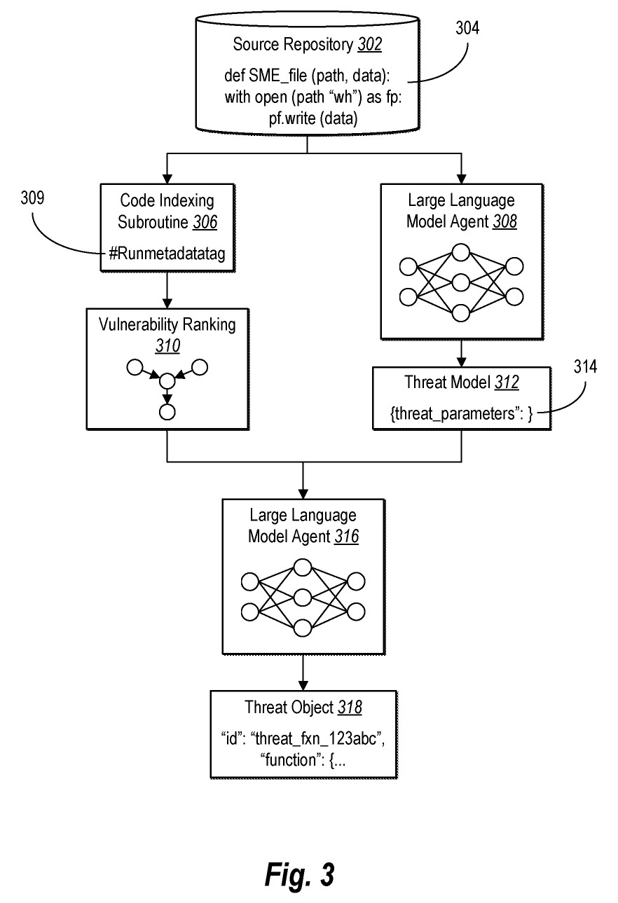

As mentioned above, the generative AI system 100 can detect vulnerabilities associated with changes to computer code in a computer application. FIG. 3 illustrates the example overview of a function threat detection system 200 generating a threat object in accordance with one or more embodiments. Additional details regarding the acts and processes introduced in relation to FIG. 3 is provided thereafter with reference to subsequent figures.

As shown in FIG. 3, the generative AI system 100 (or the function threat detection system 200) can retrieve or detect a one or more computer functions 304 from a function repository 302. For example, in some cases, the function threat detection system 200 can access and/or store computer functions of source code related to a computer application. To further illustrate, the function repository 302 can include a list, tree, directory, index, etc., comprising computer functions related to performing tasks, actions, or functions within the computer application. For example, in some cases, the one or more computer functions 304 can fetch data or a result within the computer application. Additionally, in one or more cases, the function repository 302 can include readmes, code, artifacts, objects, and/or other non-code items. In some cases, the large language model agent 316 can utilize the readmes, code, artifacts, objects, and/or other non-code items to analyze the one or more computer functions 304. As described in more detail below, the function threat detection system 200 can utilize various tools or helper tools (e.g., xref_tool, taint_path tool, BinaryXrefsTool, BinarySymbolLookuptTool, BinaryDecompileTool, BinaryDisasmTool, etc.) to analyze the one or more computer functions 304 within the function repository 302.

As FIG. 3 illustrates, in one or more cases, the function threat detection system 200 can retrieve the one or more computer functions 304 by utilizing a code indexing subroutine 306. In one or more cases, the code indexing subroutine 306 can involve finding all of the computer functions within the function repository 302 (or source code) of the computer application. For example, the function threat detection system 200 can scan the function repository 302 and discover the signatures, locations, and/or line ranges of each computer function within the function repository 302. In some cases, the function threat detection system 200 can utilize a metadata tag 309, such as, but not limited to ctags (or universal ctags), etags, gtags, and/or rtags to discover the one or more computer functions 304 within the function repository 302. For example, the function threat detection system 200 can run the metadata tag 309 over the function repository 302 to build an index (or tag file) that enumerates the computer functions. In one or more cases, the function threat detection system 200 can run one or more metadata tags over the one or more computer functions 304. In some cases, the code indexing subroutine 306 can involve a large language model agent (or large language model) discovering and/or enumerating the one or more computer functions 304. In some cases, the outputs (e.g., enumerated functions, call graph, vulnerability ranking, threat object, validated threat object, etc.,) of the large language model agents (or large language models) can be objects or artifacts that the function threat detection system 200 can send and store in a content-addressable store or cloud object storage (e.g., Azure).

As shown in FIG. 3, the function threat detection system 200 can perform a vulnerability ranking 310 on the discovered and/or enumerated computer functions. In particular, the function threat detection system 200 can generate a call graph of the one or more computer functions 304 that shows the relationships between the one or more computer functions 304. For example, the function threat detection system 200 can determine computer function callers and computer function callees and one or more call paths between the computer function callers and computer function callees. Additionally, in some implementations, the function threat detection system 200 can perform taint analysis on the call graph. In one or more embodiments, the call graph can span various language types. In one or more cases, the function threat detection system 200 can analyze the call graph to determine which computer functions from the one or more computer functions 304 lead to severe and/or critical vulnerabilities within the computer application. For example, the function threat detection system 200 can utilize one or more heuristics to quickly and efficiently rank the one or more computer functions 304 according to the severity, exploitability, etc., of the vulnerability (or bug) associated with one or more computer functions 304. Indeed, the function threat detection system 200 can prioritize the one or more computer functions 304 for more in-depth downstream analysis.

As further shown in FIG. 3, the function threat detection system 200 can utilize a large language model agent 308 associated with or within the generative AI system 100 to generate a threat model 312. In one or more cases, the large language model agent 308 can scan or analyze the one or more computer functions 304 and/or the function repository 302 to determine a program type associated with the one or more computer functions 304, the function repository, and/or the computer application. For example, the program type associated with a computer function from the one or more computer functions 304, the function repository 302, and/or computer application could be a web service, Command-Line Interface (CLI), library, and/or kernel module. In one or more cases, the large language model agent 308 can identify the program type and generate the threat model 312 that corresponds to the program type of the computer function from the one or more computer functions 304.

In one or more cases, the large language model agent 308 can generate the threat model 312 with a structured data object that defines the threat parameters 314 of the computer application. In some cases, the threat parameters 314 of the threat model 312 can define likely attack surfaces, relevant vulnerability classes, and/or threat prioritization criteria related to the one or more computer functions 304, the function repository (or source code), and/or the computer application. In one or more cases, the function threat detection system 200 can utilize an external environment source to inform the generation of the threat model 312. In particular, the function threat detection system 200 can utilize the external environment source to pull external threat data outlining and/or identifying known issues (e.g., attack surfaces and/or vulnerability classes) for given computer functions, the source code, and/or the computer application. In one or more embodiments, the function threat detection system 200 can utilize user supplied information to generate the threat model 312.

As further shown in FIG. 3, the function threat detection system 200 can utilize the one or more computer functions 304 and the threat model 312 to generate a threat object 318. In particular, the function threat detection system 200 can utilize a large language model agent 316 (or large language model agent) to analyze the one or more computer functions 304 and the threat model 312 together to determine if the one or more computer functions 304 expose the computer application to various threats and/or security risks. In particular, based on the vulnerability ranking 310, the function threat detection system 200 can determine which computer functions from the one or more computer functions 304 to perform more in-depth analysis to determine the criticality of the vulnerability tied to the computer function and/or the validity of the vulnerability associated with the computer functions. For example, the large language model agent 316 can detect a vulnerability associated with the one or more computer functions 304 and determine the severity (or risk) of the vulnerability associated with the one or more computer functions 304 and/or a likelihood of the vulnerability being leveraged by a bad actor and/or an external artificial intelligence agent. In some cases, the function threat detection system 200 can further prioritize the vulnerability associated with the one or more computer functions 304 based on the type of vulnerability.

As FIG. 3 illustrates, the large language model agent 316 can generate a threat object 318 indicating threat data associated with a computer function from the one or more computer functions 304. For example, the threat object 318 can include a description of the vulnerability associated with the computer function. In some cases, the threat object 318 can identify the severity, impact, location, patch status, validation status, etc., of the vulnerability associated with the one or more computer functions 304. For example, if the computer function leads to a vulnerability that opens the computer application to risks or threats (e.g., unauthorized access), the threat object 318 can indicate the location, the degree of severity (e.g., high, moderate, or low), and/or the fixed (or patched) status of the computer function. In some cases, the threat object 318 can be a JSON artifact comprising the threat data.

As suggested above, the function threat detection system 200 can provide several improvements or advantages over existing vulnerability detection systems. In particular, the function threat detection system 200 can provide increased security over some traditional systems. For example, the function threat detection system 200 can more accurately identify vulnerabilities within computer code (or source code) of an application which leads to the mitigation and removal of vulnerabilities and bugs from computer applications. Additionally, the function threat detection system 200 can enforce structured output schemas and validate findings (e.g., threat objects) which prevents corrupted or misleading results that might otherwise weaken the security of the computer application. Moreover, the function threat detection system 200 improves the security of existing vulnerability detection systems. For example, the function threat detection system 200 can isolate vulnerability analysis from the control plane by executing code analysis within isolated containers. This separation prevents prompt injection attacks or other adversarial inputs from contaminating orchestration logic or accessing sensitive resources. By enforcing isolation, the function threat detection system 200 ensures that untrusted source code is only processed in controlled environments, thereby preserving the integrity of security decisions of the function threat detection system 200 itself and/or the large language models utilized by the function threat detection system 200.

On top of improved security, the function threat detection system 200 can provide increased flexibility. For example, the function threat detection system 200 can utilize language-agnostic vulnerability analysis across heterogeneous repositories. Unlike conventional systems bound to fixed parsers or language-specific abstract syntax trees, the function threat detection system 200 can enumerate and analyze functions in a wide variety of programming languages, frameworks, and application types. By leveraging call graph construction, taint propagation, and large language model-assisted reasoning, the function threat detection system 200 can accurately identify vulnerabilities that span multiple functions, modules, or even mixed-language systems. Such flexibility enables the function threat detection system 200 to adapt to evolving development practices and maintain relevance across diverse software environments.

In addition to improved security and flexibility, the function threat detection system 200 can provide enhanced computational efficiency compared to conventional approaches. Rather than repeatedly scanning entire repositories, the function threat detection system 200 employs heuristic ranking to prioritize security-relevant functions for deep analysis. This targeted approach avoids redundant work, reduces runtime, and preserves computational resources. Moreover, by distributing analysis tasks across isolated containers, the function threat detection system 200 can parallelize workloads and scale efficiently to large repositories and complex architectures. Such efficiency makes the system well-suited for integration into continuous integration and deployment pipelines, where rapid and accurate vulnerability detection is essential.

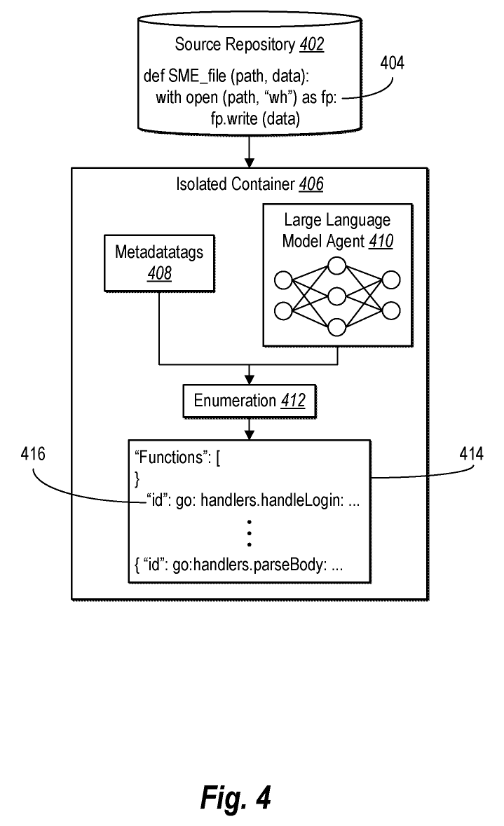

As indicated above, the function threat detection system 200 can discover and/or enumerate one or more computer functions stored within a function repository. FIG. 4 illustrates the function threat detection system 200 importing one or more computer functions in accordance with one or more embodiments.

As shown in FIG. 4, the function threat detection system 200 can generate an isolated container 406 and utilize a code indexing subroutine within the isolated container 406 to scan a function repository 402. Accordingly, the function threat detection system 200 can identify a computer function 404 and/or one or more computer functions from the function repository 402. For example, the function threat detection system 200 can apply one or more heuristics or a language-agnostic data parser, such as a metadata tag 408 (or one or more metadata tags), to identify the name, files, location, and/or line ranges associated with the computer function 404. In some embodiments, the function threat detection system 200 can apply a ctag to the computer function 404 to identify metadata associated with the computer function 404. Indeed, the function threat detection system 200 can discover computer functions across different programming languages. For example, the function threat detection system 200 can discover within the function repository (or source code) a first computer function written in Python and a second computer function written in JavaScript. Unlike existing systems, the function threat detection system 200 can perform language-agnostic parsing without utilizing a compilation step.

In one or more cases, the function threat detection system 200 can utilize a large language model agent 410 to discover the computer function 404 and/or the one or more functions from the function repository 402. For example, the function threat detection system 200 can segment the one or more computer functions within the function repository 402 according to a code window and input the one or more computer functions within the code window into the large language model agent 410. In one or more cases, the code window can include a segment of computer code from the function repository 402 and/or the source code. For example, the context window can comprise a computer function and surrounding context (e.g., imports, comments, adjacent computer functions, etc.). In some cases, the function threat detection system 200 can utilize a sliding window context or multi-function context windows based on strong couplings between two or more computer functions.

In some cases, the function threat detection system 200 can utilize the metadata tag 408 (e.g., ctag) together with the large language model agent 410 to discover the computer function 404 and/or the one or more computer functions from the function repository 402. For example, the function threat detection system 200 can utilize the metadata tag 408 to accelerate function discovery by the large language model agent 410. For example, the function threat detection system 200 can utilize the metadata tag 408 (or a plurality of metadata tags) to identify interesting or relevant computer functions that can be fed into the large language model agent 410 for additional discovery (or enumeration) processing.

As further shown in FIG. 4, the function threat detection system 200 can perform an enumeration step 412 on the computer function 404 and/or the one or more functions discovered by the metadata tag 408 and/or the large language model agent 410 as part of the code indexing subroutine. For example, the function threat detection system 200 can further analyze the segment of computer code comprising the computer function 404 according to the context window to identify the name, location, boundaries, arguments, return variables, signatures, internal calls, etc. associated with the computer function 404. In some cases, the function threat detection system 200 can utilize one or more heuristics (e.g., static function discovery) to identify metadata and/or definitions of the function repository 402 or the one or more computer functions from the function repository 402.

As further shown in FIG. 4, the function threat detection system 200 can generate an enumerated computer function index 414 comprising an enumerated computer function 416 of the function repository 402 and/or a list of one or more enumerated computer functions from the function repository 402. In one or more cases, the function threat detection system 200 can utilize the enumerated computer function index 414 to generate a call graph.

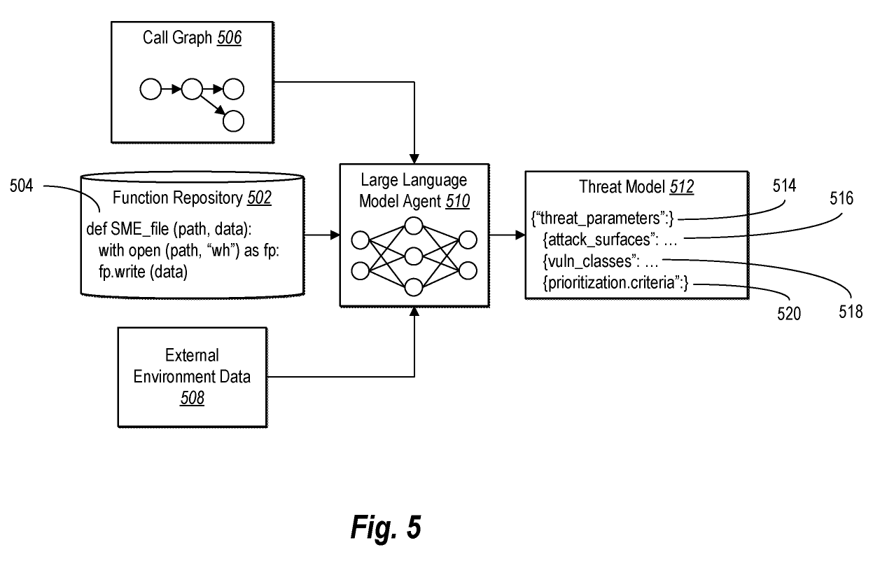

As mentioned above, the function threat detection system 200 can detect vulnerabilities within computer code utilizing a threat model. In one or more cases, the function threat detection system 200 can generate a threat model that identifies and/or exposes bugs that open the computer application to security risks. FIG. 5 illustrates the function threat detection system 200 generating a threat model in accordance with one or more embodiments.

As shown in FIG. 5, the function threat detection system 200 can provide one or more computer functions 504 (as enumerated functions or computer functions from a function repository 502) and/or a call graph 506 to a large language model agent 510. In one or more cases, the large language model agent 510 can generate a threat model 512 that defines the threat parameters 514 specific to computer functions. For example, the function threat detection system 200, via the large language model agent 510, can define relevant (or likely) attack surfaces 516, relevant vulnerability classes 518, and/or threat prioritization criteria 520 tailored to computer functions. In one or more embodiments, the threat model 512 is language agnostic based on the mappings and/or annotations of the call graph 506.

In one or more cases, the function threat detection system 200 can utilize information from the call graph 506 to inform the large language model agent 510 during the generation of the threat model 512. For example, based on heuristic scanners marking the call graph 506 with candidate entry points, likely surface attacks, such as sinks, trust boundaries, computer function metadata, function repository (or source code) metadata, etc., the large language model agent 510 can generate the threat model 512 that provides context, via the threat parameters 514, that outline potential attackers, reachable attack surfaces (or vulnerable code regions), trust boundaries, relevant vulnerability classes, etc. As further shown in FIG. 5, the function threat detection system 200 can utilize external threat data from an external environment source 508 to further inform the large language model of known vulnerabilities, bug tracker issues, and/or dependency advisories associated with the one or more computer functions and/or the computer application. In one or more cases, the function threat detection system 200 can receive user supplied data indicating a bug or vulnerability associated with the one or more computer functions 504 and/or the computer application.

As mentioned above, the function threat detection system 200, via the large language model agent 510, can define relevant attack surfaces 516. For example, the large language model agent 510 can define (or identify) surfaces (or regions) where a bad actor can interact with or influence computer functions within the computer application. In one or more embodiments, the relevant attack surfaces 516 can include network ports, file inputs, file uploads, HTTP inputs, SQL queries, buffer writes, key handling, third-party dependencies, command-line interfaces (CLIs), access controls, supply chains, etc.

Additionally, the large language model agent 510 can define the relevant vulnerability classes 518. For example, the large language model agent 510 can define injection flaws (e.g., SQL injection), cross-site scripting (XSS), authentication flaws, path issues, cryptographic issues, memory safety issues (e.g., buffer overflow), integer overflows, format-string vulnerabilities, authentication bypasses, authorization bypasses, path traversals, information disclosures, etc., as the relevant vulnerability classes 518. Moreover, the large language model agent 510 can outline signals indicating that a computer function from the one or more computer functions 504 corresponds to a given vulnerability class. For example, the threat model 512 can define an SQL injection flaw that allows an attack to interfere with one or more queries made by a given computer function as a relevant vulnerable class that should be prioritized and analyzed further.

Moreover, the large language model agent 510 can define the threat prioritization criteria 520. In one or more cases, the threat prioritization criteria 520 can be a scoring framework that weighs the importance of vulnerabilities associated with the one or more computer functions 504. For example, the threat prioritization criteria 520 can define how the threat model 512 weighs the severity (or criticality) of the relevant vulnerability classes 518, the likelihood (or reachability) of triggering the vulnerability, the sensitivity of the data (e.g., PII, authentication logic, payment flows, etc.) related to the vulnerability, and/or the exploitability of the vulnerability. To further illustrate, the function threat detection system 200 can weigh the exploitability of the vulnerability based on the availability and/or knowledge of exploitative techniques. In some cases, the threat prioritization criteria 520 can weigh the relevant vulnerability classes 518 based on the relevant attack surfaces 516.

In one or more cases, the function threat detection system 200 can receive one or more user inputs modifying the threat model 512, or more specifically, the structured data object defining the threat parameters 514. For example, the function threat detection system 200 can receive one or more user interactions adding, removing, and/or modifying the relevant attack surfaces 516 and/or the relevant vulnerability classes 518. In one or more cases, the function threat detection system 200 can receive one or more user inputs modifying the relevant vulnerability classes 518 by adding and/or removing vulnerability classes or signals indicating a vulnerability associated with the relevant vulnerability classes 518. Moreover, the function threat detection system 200 can receive one or more user inputs (or interactions) modifying the threat prioritization criteria 520 of the threat model 512. For example, the function threat detection system 200 can receive one or more user interactions, increasing and/or decreasing the weights for the severity of the relevant vulnerability classes 518, the likelihood of triggering the vulnerability, the sensitivity of the data, and/or the exploitability of the vulnerability. In one or more cases, based on receiving the one or more user interactions modifying the threat parameters 514, the function threat detection system 200 can update the threat model 512 and/or the threat parameters 514 of the threat model 512.

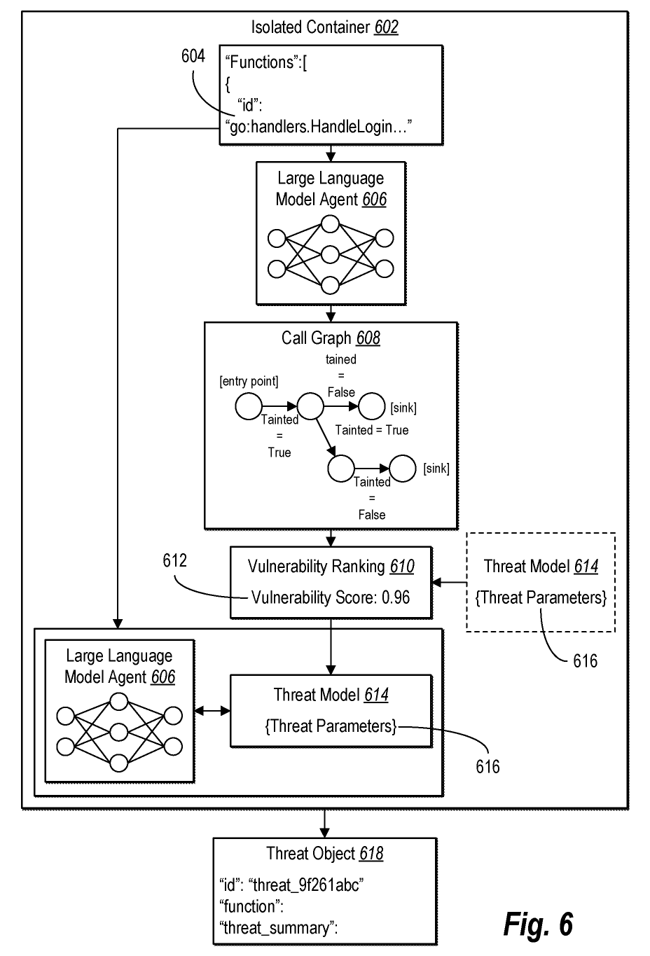

As just discussed, the function threat detection system 200 can generate a threat model to provide context to a large language model that analyzes one or more computer functions. In one or more cases, the function threat detection system 200 can further analyze the one or more computer functions to generate a threat object indicating vulnerabilities within the computer code. FIG. 6 illustrates the function threat detection system 200 generating a call graph and utilizing the call graph to generate a threat object by analyzing a computer function within the call graph with a large language model and a threat model within an isolated container in accordance with one or more embodiments.

As shown in FIG. 6, the function threat detection system 200 can generate (or launch) an isolated container 602 for analyzing one or more enumerated computer functions 604. In one or more cases, the isolated container 602 is an isolated execution environment (or isolated capability-gated container) that prevents a large language model 606 and/or agent that is performing analysis on the one or more computer functions from accessing a control plane. For example, the large language model 606 cannot access control-plane code, configuration, and/or secrets during analysis in the isolated container 602. In one or more cases, the isolated container 602 is a short-lived isolated container and controls access of the large language model 606 to a computer function or a subset of computer functions from the one or more enumerated computer functions 604. Moreover, FIG. 6 shows an embodiment where the function threat detection system 200 utilizes a single isolated container. In one or more cases, the function threat detection system 200 can utilize any number of isolated containers ranging from one to billions of isolated containers that analyze one or more computer functions in parallel. Thus, the function threat detection system 200 can enable massive parallelization of computer function vulnerability analysis.

As discussed above, the function threat detection system 200 can enumerate computer functions utilizing a code indexing subroutine. In one or more cases, the function threat detection system 200 can process an enumerated computer function index comprising the one or more enumerated computer functions with the large language model 606 to generate a call graph 608.

As further shown in FIG. 6, the function threat detection system 200 can analyze the one or more computer functions and associated vulnerabilities utilizing the threat model 614 in the isolated container 602 by generating a call graph (or directed graph) of the one or more enumerated computer functions 604 from the function repository (or source code). For example, the function threat detection system 200 can utilize the large language model 606 to generate one or more lists of direct callee functions of the one or more enumerated computer functions. For example, for a given enumerated computer function (or computer function), the large language model 606 can identify one or more other computer functions that are directly invoked by the enumerated computer function under analysis. In one or more cases, the function threat detection system 200, via the large language model 606, can generate the call graph 608 comprising one or more nodes representing the one or more enumerated computer functions based on the one or more lists of direct callees. In one or more embodiments, the function threat detection system 200 can utilize one or more heuristics to determine the lists of direct callee functions. Accordingly, if the one or more heuristics cannot resolve ambiguous or dynamic callee functions, the function threat detection system 200 can utilize the large language model 606 to confirm or determine the correct direct function callee functions.

In one or more cases, the function threat detection system 200 can generate edges (e.g., F → callee) for all of the direct callee functions of the one or more enumerated functions. In some cases, the function threat detection system 200 can utilize a NetworkX graph (or network.DiGraph) from Python to store the edges (or directed edges) of the call graph 608. Additionally, the function threat detection system 200 can utilize checkpoints to enable resumability and increase scale and fault tolerance. For example, the function threat detection system 200 can persist intermediate snapshots (e.g., callgraph.json) after processing a batch of computer functions to generate the call graph 608 so that the function threat detection system 200 does not need to re-query the large language model 606 for already processed computer functions.

As further shown in FIG. 6, the call graph 608 can be an annotated call graph. In one or more cases, the function threat detection system 200 can annotate the one or more nodes and/or edges of the call graph 608 with security-relevant metadata. For example, the function threat detection system 200 can annotate the nodes and edges with one or more taint attributes and/or boundaries. To further illustrate, the function threat detection system 200 can label a node (or computer function) as an entry point, a source, and/or a sink. Moreover, the function threat detection system 200 can determine whether an edge propagates taint (or a vulnerability) through the nodes (or computer functions. In one or more cases, the function threat detection system 200 can utilize one or more heuristics to annotate the one or more nodes and/or the one or more edges of the call graph 608.

In some cases, the large language model 606 can annotate the nodes and/or edges of the call graph 608. For example, the large language model 606 can determine if a computer function receives an untrusted input, invokes a privileged API, or sanitizes data. Moreover, the large language model can annotate how taint flows over an edge (e.g., taint preserved, taint sanitized, unknown) or boundary crossings. Accordingly, the function threat detection system 200 can determine if one or more call paths propagate vulnerabilities (or tainted attributes) across the call graph 608. Thus, in one or more cases, edges (or path flows) propagating a vulnerability (or taint) from a source computer function to a sink computer function are candidates for exposing the vulnerabilities of a computer application for malicious misuse.

As further shown in FIG. 6, the function threat detection system 200 can perform a vulnerability ranking 610 to prioritize in-depth analysis of the riskier and/or more vulnerable computer functions from the one or more computer functions (or the one or more enumerated computer functions 604) In particular, the function threat detection system 200 can combine taint annotations (or indicators), static heuristics, and/or call graph metrics to prioritize specific computer functions for more in-depth analysis and triage. For example, the function threat detection system 200 can generate a vulnerability score 612 for each computer function in the call graph 608, or the enumerated computer function index. In some cases, the function threat detection system 200 can generate a set of vulnerability rankings for a set of computer functions based on annotating the function calls (e.g., direct function calls or indirect function calls) within the call graph 608.

In one or more cases, the vulnerability score 612 indicates an initial severity, an initial likelihood, and/or a potential impact that the computer function contributes to an exploitable vulnerability. In one or more cases, the function threat detection system 200 can utilize heuristics and attributes from the call graph 608, such as, but not limited to proximity to entry point, taint reaching privileged or sensitive sinks, no detected sanitizers, and/or sink type to generate the vulnerability score 612 indicating a likelihood and/or potential impact of the vulnerability associated with the computer function. As indicated above, in some cases, the function threat detection system 200 can utilize heuristic scoring of the attributes of the call graph 608 to determine the vulnerability score 612. Accordingly, a higher vulnerability score 612 leads to higher prioritization of analyzing the corresponding computer function, and a lower vulnerability score 612 indicates a lower priority of in-depth analysis of the corresponding computer function. In some cases, the function threat detection system 200 can generate an output comprising the vulnerability score 612 and the weights and/or heuristic rules that led to the vulnerability score 612.

Moreover, in one or more implementations, the function threat detection system 200 can rank the one or more enumerated computer functions 604 (or computer functions) according to corresponding vulnerability scores. In some embodiments, the function threat detection system 200 can utilize the large language model 606 and/or the threat model 614 comprising the threat parameters 616 to determine the vulnerability score 612. For example, in one or more cases, the threat parameters 616 can help define the relevant attack surfaces and/or the relevant vulnerability classes. For example, the function threat detection system 200 can modify the heuristic weights applied to a given vulnerability class based on the attack surface associated with the computer function.

Additionally, in one or more cases, function threat detection system 200 can select a subset of enumerated computer functions (or computer functions) from the one or more enumerated computer functions 604 for additional analysis based on the vulnerability ranking 610. For example, the function threat detection system 200 can select the top-K computer functions for deeper analysis by the large language model 606 and the threat model 614.

As just mentioned, the function threat detection system 200 can utilize the large language model 606 together with the threat model 614 to analyze high-risk computer functions. In some cases, the function threat detection system 200 can generate (or spawn) a fresh large language model or large language model agent to analyze each high-risk computer function. In some cases, the function threat detection system 200 can make available various tools (e.g., helper tools) that the large language model 606 can utilize to determine if the computer function exposes the computer application to security threats. For example, the large language model 606 can utilize the threat model 614 and the threat parameters 616 to perform interprocedural analysis on the subset of high-risk computer functions. For example, the threat model 614 can provide context about relevant attack surfaces, vulnerability classes, and/or threat prioritization criteria to the large language model 606 as the large language model 606 evaluates sanitizers, determines the shortest call path from an entry point (or source) to a sensitive sink, notes boundary crossings, etc., the large language model 606 can utilize the threat model to determine or confirm the severity, impact, likelihood, and/or exploitability of the vulnerability associated with the computer function. Indeed, the function threat detection system 200 can provide the large language model 606 with one or more tools that enable interprocedural analysis of the one or more enumerated computer functions 604 and/or the call graph 608. For example, the function threat detection system 200 can utilize the call graph 608, taint metadata, and/or ranking signals to enable the interprocedural analysis.

As shown in FIG. 6, in one or more cases, the large language model 606 can generate a threat object 618 comprising threat data reflecting the criticality, description, and/or bugs related to a computer function from the one or more enumerated computer functions 604 (or one or more computer functions). For example, the threat object 618 can include information about the vulnerability class, the severity/likelihood of a bad actor leveraging the computer function, evidence indicating a specific taint path (or data flow) between computer functions, a list of computer function caller and computer function callees, evidence, trust boundaries, and/or a recommended action (or fix) addressing the vulnerability associated with the computer function. Indeed, the function threat detection system 200 can generate a structured output (e.g., threat object 618) that makes triaging vulnerabilities faster and easier. In some cases, the function threat detection system 200 can generate sets of threat objects for sets of computer functions based on sets of vulnerability rankings.

In some implementations, the function threat detection system 200 can generate a JSON artifact of the threat object 618 and post the threat object 618 to a communication channel (e.g., Slack channel), a disk, a web interface, and/or an API. As described in more detail below, in one or more cases, the function threat detection system 200 can receive one or more user inputs about the findings associated with the threat object 618. In some cases, function threat detection system 200 can filter the threat object 618 with an additional large language model or heuristic model based on security relevance before publishing the threat object 618 to the communication channel, the web interface, etc. In one or more implementations, the function threat detection system 200 can generate a set of threat objects associated with analyzing the computer function (or enumerated computer function) in the isolated container 602. Additionally, in some cases, the function threat detection system 200 can generate a set of threat objects for a set of computer functions (or enumerated computer functions) based on the function threat detection system 200 performing parallel analysis of the set of computer functions across a set of isolated containers.

In some embodiments, when utilizing one or more large language model agents, the function threat detection system 200 can implement stigmergic coordination among large language model agents, wherein the large language model agents indirectly coordinate through a content-addressable store by observing, producing, and/or updating large language model agent outputs, such as, shared artifacts (or artifacts) or shared objects (or objects). For example, one or more large language model agents can read and/or write shared artifacts and/or shared objects (or objects) through the content-addressable store by utilizing one or more stigmergic agentic algorithms. To further illustrate, in one or more cases, each large language model agent can write and store deterministic artifacts as objects to the content-addressable store. Relatedly, the one or more additional large language model agents can observe the one or more artifacts (or objects) and determine when to merge, rank, decompile, validate, etc. existing, additional, and/or new artifacts (e.g., shared artifacts) or objects stored in the content-addressable store utilizing the stigmergic agentic algorithms. Thus, the binary threat detection system 200, via stigmergic coordination, enables decentralized task allocation and conflict resolution without requiring direct inter-agent communication. In some cases, the function threat detection system 200 can pause and/or resume processing of one or more binary functions by hydrating and/or rehydrating the artifacts or objects within one or more (e.g., set of) isolated containers.

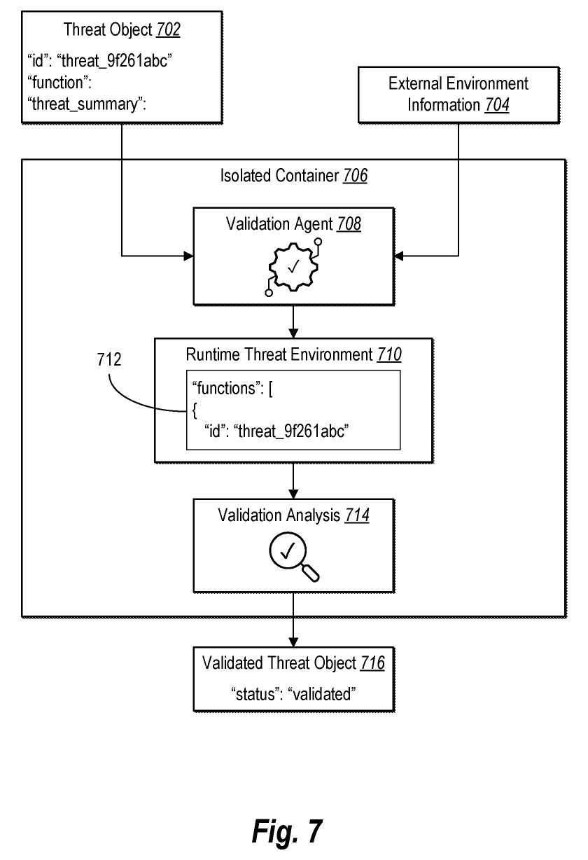

As just described, the function threat detection system 200 can generate a threat object indicating threat data associated with a computer function. In some cases, the function threat detection system 200 can validate the threat object before publishing the threat object to the communication channel, the web interface, etc., to confirm the existence of the vulnerability associated with the computer function and further understand the impact and risk associated with the computer function. FIG. 7 illustrates the function threat detection system 200 validating a threat object utilizing a validation agent in accordance with one or more embodiments.

As shown in FIG. 7, the function threat detection system 200 can generate an isolated container 706 (or an additional isolated container). In one or more cases, the isolated container 706 is an isolated container-as-a-service (CaaS) container that prevents interference with control-plane code or other environments. Moreover, in some cases, the isolated container 706 is a short-lived, capability-gated container where the validation agent 708 has no access to control-plane code, configurations, and/or secrets. As shown in FIG. 7, the function threat detection system 200 can analyze a threat object 702 and external environment information 704 with a validation agent 708 within the isolated container 706. In some cases, the external environment information 704 can provide external information about the runtime threat environment 710. In particular, the function threat detection system 200 can generate a runtime threat environment 710 by cloning the computer function 712, one or more additional and/or adjacent computer functions associated with the threat object 702 (or computer function 712), caller/callee paths, etc., associated with the threat object 702 in a debug configuration. For example, as shown in FIG. 7, the function threat detection system 200 can generate a cloned computer function based on the threat object 702.

As further shown in FIG. 7, the function threat detection system 200 can execute the runtime threat environment 710 and perform validation analysis 714 on the runtime threat environment 710. For example, the function threat detection system 200 can apply the relevant proof-of-concept (POC) or a test harness associated with the vulnerability (or bug) and run the runtime threat environment 710 under analysis tools (e.g., Valgrind, sanitizers, etc.) to detect (or confirm) the one or more vulnerabilities. For example, the validation agent 708 can detect and/or confirm memory safety errors, such as, but not limited to, buffer overflows, race conditions, and/or out-of-bounds reading/writing.

In one or more cases, the validation agent 708 can detect other flaw types, such as, but not limited to, injection and data flow flaws (e.g., SQL injection, command injection, cross-site scripting), authentication and access controls (e.g., improper authentication), resource management (e.g., improper input validation), cross-site scripting (XSS), path issues, or cryptographic issues. In some cases, the validation analysis 714 can include fuzz payloads, taint replay, and/or symbolic execution to confirm vulnerabilities.

Thus, the validation agent 708 can utilize the validation analysis 714 to trace vulnerability conditions across multiple computer functions and/or files associated with the cloned version of the computer function 712. In one or more cases, the validation analysis 714 can act as a code simulation to compile and run computer functions to test for bugs in the codebase that lead to vulnerabilities. For example, in one or more cases, the validation agent 708 can detect a bug associated with a computer function and included in the threat object 702 that feeds or leads to a vulnerability in the codebase. Thus, the validation analysis 714 can confirm (or verify) the existence of a bug (or one or more bugs) defined in the threat object 702. In one or more cases, the function threat detection system 200 can update the ranking heuristics based on a confirmed, unconfirmed, and/or inconclusive finding regarding the vulnerability and the computer function 712. For example, the function threat detection system 200 can modify weights and/or boost signals in the heuristic rules for confirmed vulnerabilities associated with the computer function 712. Thus, the function threat detection system 200 can adapt and become more accurate based on confirming vulnerabilities in the function repository (or source code) of the computer application.

In one or more cases, the function threat detection system 200 can confirm the existence of the vulnerability associated with the computer function based on the validation agent 708 reproducing the vulnerability in the isolated container 706. For example, the function threat detection system 200 can determine if a payload from a source reached a sink without going through a sanitizer. The function threat detection system 200 can generate a validated threat object 716 based on the validation agent 708 confirming the vulnerability associated with the cloned version of the computer function 712. In one or more cases, if the validation agent 708 and the validation analysis 714 do not reproduce the vulnerability associated with the cloned version of the computer function 712, the function threat detection system 200 can mute or deprioritize the vulnerability associated with the cloned version of the computer function 712.

As indicated above, in one or more cases, the validated threat object 716 can be a structured output comprising threat data (or validated threat data) associated with the cloned version of the computer function 712. For example, the validated threat object 716 can include validation logs, proof of concept source code (e.g., code snippet), and/or environment details. In some cases, the validated threat object 716 can include a validation status (e.g., success or failure) indicating confirmation of the vulnerability, along with a summary of the trigger conditions associated with the vulnerability. In one or more cases, the function threat detection system 200 can save the validated threat object 716 to a local disk as a JSON and send structured messages and/or reports based on the validated threat object 716 to a chat platform (e.g., Slack), an API endpoint, and/or to a web interface.

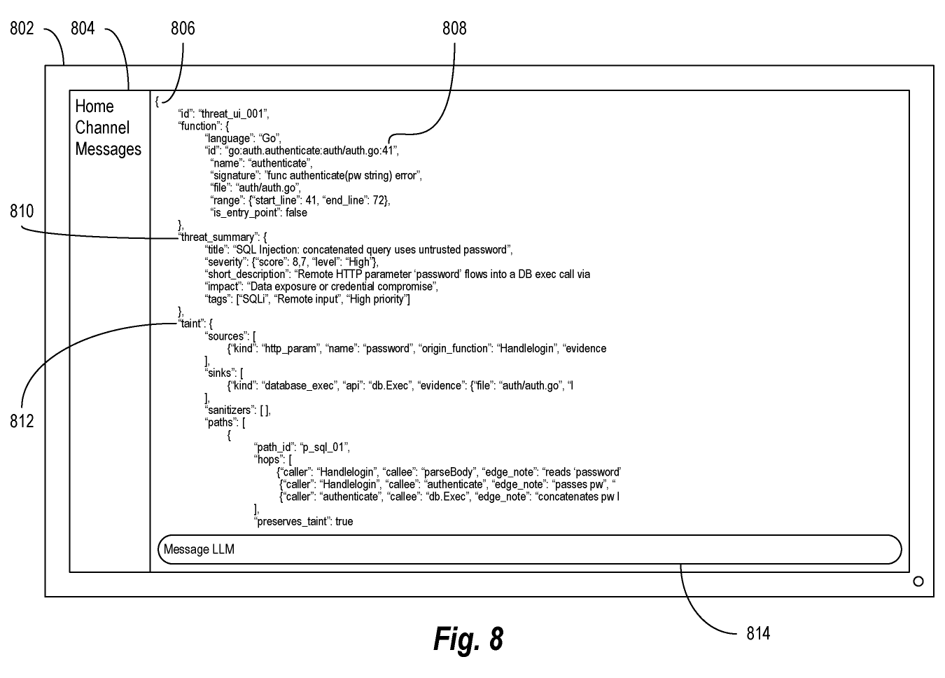

As just discussed, the function threat detection system 200 can generate a threat object and/or a validated threat object that outlines threat data associated with a computer function. The function threat detection system 200 can further provide and modify a graphical user interface for reviewing computer functions associated with a threat object. FIG. 8 illustrates an exemplary graphical user interface presenting a threat object (or validated threat object) in accordance with one or more embodiments.

As shown in FIG. 8, the function threat detection system 200 can provide for display on a graphical user interface 804 of a client device 802 a threat object 806 (or a message associated with the threat object 806). As shown in FIG. 8, the threat object 806 can include information identifying a computer function 808, summarizing the vulnerability (e.g., threat summary 810), taint attributes 812, and/or a vulnerability score. Indeed, the threat object 806 can inform a user account associated with the computer function 808, the function repository (or source code), and/or the computer application of important information about the vulnerability associated with the computer function 808.

In one or more cases, the threat object 806 or (message associated with the threat object 806) can include evidence about the vulnerability associated with the computer function 808. For example, the threat object 806 can include a source and sink (or computer function caller/callee) and the call path (or execution path) that propagated a bug associated with the vulnerability.

Indeed, the threat object 806 can provide a human-readable name and a threat summary 810 and/or explanation of the vulnerability and corresponding computer function 808. In some cases, the threat object 806 can indicate the severity or level of risk associated with the vulnerability, as well as the impact of the vulnerability on the affected source code. In some cases, the threat object 806 can include information about how the vulnerability can be exploited. In one or more cases, the threat object 806 can indicate the location and whether the vulnerability is patched, unpatched, and/or under review.

As further shown in FIG. 8, the threat object 806 or (message associated with the threat object 806) can include a recommended action for addressing the vulnerability. For example, the function threat detection system 200 can suggest tests and/or patches to apply to one or more computer functions (or the source code) based on the vulnerability class associated with the vulnerability. For example, the function threat detection system 200 can generate the recommended action for addressing SQL injection flaws. In some cases, a validation agent, as described above in FIG. 7, can validate the recommended action and confirm whether the recommended action (or fix) addresses the vulnerability. Relatedly, in one or more cases, the

As further shown in FIG. 8, the function threat detection system 200 can receive one or more user interactions via an input field 814. In some cases, the function threat detection system 200 can support an interactive chat, via a large language model and/or agent (e.g., large language model agent or validation agent), discussing the one or more findings included in the threat object 806. For example, the function threat detection system 200 can receive one or more user inputs requesting additional threat information about the threat object 806. To further illustrate, the function threat detection system 200 can receive one or more user inputs requesting more information about the vulnerability score and/or the one or more threat parameters associated with the threat model. Accordingly, the function threat detection system 200 can generate a response, utilizing a large language model, that includes the additional threat information. For example, the function threat detection system 200 can return more details about the vulnerability score and/or the threat parameters.

In some cases, the function threat detection system 200 can modify and/or update the threat object 806 to highlight or include information deemed important by the user account based on receiving one or more user interactions. For example, the function threat detection system 200 can receive user input indicating that the user account associated with the 802 prefers a longer threat summary 810. In some cases, the function threat detection system 200 can formulate the threat object 806 based on the preferences of the user account generating, reviewing, and/or utilizing the threat object 806.

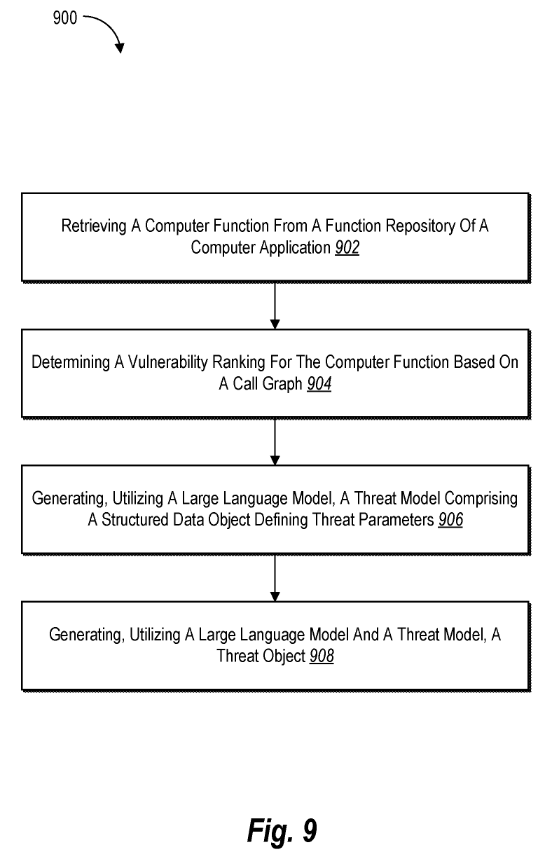

FIGS. 1-8, the corresponding text, and the examples provide a number of different systems and methods for detecting vulnerabilities and potential threats in a computer application based on computer functions. In addition to the foregoing, implementations can also be described in terms of flowcharts comprising acts or steps in a method for accomplishing a particular result. For example, FIG. 9 illustrates an example series of acts performed by the function threat detection system 200 in accordance with one or more embodiments.

While FIG. 9 illustrates acts according to certain implementations, alternative implementations may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In still further implementations, a system can perform the acts of FIG. 9.

As illustrated in FIG. 9, a series of acts 900 may include an act 902 of retrieving a computer function from a function repository of a computer application, an act 904 of determining a vulnerability ranking for the computer function based on a call graph, an act 906 of generating, utilizing a large language model, a threat model comprising a structured data object defining threat parameters, and an act 908 of generating, utilizing a large language model and a threat model, a threat object.

In one or more embodiments, the series of acts 900 can include acts to perform any of the operations described in the following clauses:
CLAUSE 1. A computer-implemented method comprising: retrieving, utilizing a code indexing subroutine, a computer function from a function repository of a computer application; determining a vulnerability ranking for the computer function based on a call graph defining relationships among computer functions of the computer application; generating, utilizing a large language model of a generative artificial intelligence (AI) system, a threat model comprising a structured data object defining threat parameters corresponding to the computer application; and generating, based on the vulnerability ranking and by utilizing a large language model to analyze the computer function together with the threat model, a threat object indicating threat data associated with the computer function.
CLAUSE 2. The computer-implemented method of clause 1, wherein utilizing the code indexing subroutine comprises scanning the function repository utilizing a large language model to identify the computer function.
CLAUSE 3. The computer-implemented method of any of clauses 1 to 2, wherein generating the threat model comprises utilizing the large language model to define the threat parameters of the computer application comprising at least one of a relevant attack surface of the computer application, a relevant vulnerability class of the computer application, or a threat prioritization criteria of the threat model.
CLAUSE 4. The computer-implemented method of any of clauses 1 to 3, wherein generating the call graph further comprises: generating, utilizing the large language model, a data structure defining relationships between the computer function and other computer functions of the computer application. CLAUSE 5. The computer-implemented method of any of clauses 1 to 4, further comprising: generating the threat object by utilizing the large language model and the threat model in an isolated container, wherein the isolated container controls access of the large language model.
CLAUSE 6. the computer-implemented method of any of clauses 1 to 5, further comprising: building a runtime threat environment comprising a cloned version of the computer function based on the threat object; and generating, utilizing the large language model within the runtime threat environment, a validated threat object indicating a confirmation of the threat data associated with the computer function based on analyzing an execution of the cloned version of the computer function within the runtime threat environment.
CLAUSE 7. The computer-implemented method of any of clauses 1 to 6, further comprising: receiving, from an external environment source, external threat data outlining one or more vulnerabilities associated with the computer application; and generating the threat model based on informing the large language model with the external threat data.
CLAUSE 8. A system comprising: at least one processor; and a non-transitory computer-readable medium storing instructions which, when executed by the at least one processor, cause the system to: retrieve, utilizing a code indexing subroutine, a computer function from a function repository of a computer application; determine a vulnerability ranking for the computer function based on a call graph defining relationships among computer functions of the computer application, wherein the vulnerability ranking involves determining a vulnerability score indicating an initial severity of a vulnerability associated with the computer function; generate, utilizing a large language model of a generative artificial intelligence (AI) system, a threat model comprising a structured data object defining threat parameters corresponding to the computer application; and generate, based on the vulnerability ranking and by utilizing a large language model to analyze the computer function together with the threat model, a threat object indicating threat data associated with the computer function.
CLAUSE 9. The system of clause 8 further comprising instructions which, when executed by the at least one processor, cause the system to discover the computer function by scanning the function repository utilizing a large language model according to a code window.
CLAUSE 10. The system of any of clauses 8 to 9, further comprising instructions which, when executed by the at least one processor, cause the system to: identify the threat parameters corresponding to at least one of relevant attack surfaces, relevant vulnerability classes, or threat prioritization criteria of the threat model; receive one or more user inputs modifying at least one of the relevant attack surfaces, the relevant vulnerability classes, or the threat prioritization criteria of the threat model; and update the threat parameters based on the one or more user inputs.
CLAUSE 11. The system of any of clauses 8 to 10further comprising instructions which, when executed by the at least one processor, cause the system to: annotate function calls among the computer functions with taint attributes based on at least one of data sources, sinks, or data flows of the function calls; and determine the vulnerability ranking for the computer function based on annotating the function calls.
CLAUSE 12. The system of any of clauses 8 to 11further comprising instructions which, when executed by the at least one processor, cause the system to generate the threat object by utilizing the large language model and the threat model in an isolated container, wherein the isolated container defines a boundary between the large language model and a control plane.
CLAUSE 13. The system of any of clauses 8 to 12further comprising instructions which, when executed by the at least one processor, cause the system to: generate an isolated container comprising a validation agent; build, within the isolated container, a runtime threat environment comprising a cloned version of the computer function associated with the threat object; and validate the threat object by analyzing, utilizing the validation agent, an execution of the cloned version of the computer function within the runtime threat environment by indicating a confirmation of the threat data associated with the computer function.
CLAUSE 14. The system of any of clauses 8 to 13further comprising instructions which, when executed by the at least one processor, cause the system to: provide for display within a graphical user interface the threat object, wherein the threat object comprises a threat summary; receive from a client device, via an input field, within the graphical user interface, one or more user inputs requesting additional threat information about the threat object; and generate, utilizing a large language model, a response comprising the additional threat information.
CLAUSE 15. A non-transitory computer-readable medium storing executable instructions which, when executed by at least one processor, cause the at least one processor to: retrieve, utilizing a code indexing subroutine, a set of computer functions from a function repository of a computer application; determine a set of vulnerability rankings for the set of computer functions based on a call graph defining relationships among computer functions of the computer application; generate, utilizing a large language model of a generative artificial intelligence (AI) system, a threat model comprising a structured data object defining threat parameters corresponding to the computer application; and generate, based on the set of vulnerability rankings and by utilizing a large language model to analyze the set of computer functions together with the threat model, a set of threat objects indicating threat data associated with the set of computer functions.
CLAUSE 16. The non-transitory computer-readable medium of clause 15, wherein utilizing the code indexing subroutine comprises discovering the set of computer functions by scanning the function repository utilizing metadata tags.
CLAUSE 17. The non-transitory computer-readable medium of any of clauses 15 to 16, further storing instructions which, when executed by the at least one processor, cause the at least one processor to: indirectly coordinate a reading and writing of one or more shared objects by one or more large language model agents on a content-addressable store utilizing one or more stigmergic agentic algorithms.
CLAUSE 18. The non-transitory computer-readable medium of any of clauses 15 to 17, further storing instructions which, when executed by the at least one processor, cause the at least one processor to: annotate function calls among the computer functions with security-relevant metadata; and determine the set of vulnerability rankings for the set of computer functions based on annotating the function calls.
CLAUSE 19. The non-transitory computer-readable medium of any of clauses 15 to 18, further storing instructions which, when executed by the at least one processor, cause the at least one processor to: generate the set of threat objects by utilizing the large language model and the threat model in an isolated capability-gated container, wherein the isolated capability-gated container defines a boundary between the large language model and a control plane.
CLAUSE 20. The non-transitory computer-readable medium of any of clauses 15 to 19, further storing instructions which, when executed by the at least one processor, cause the at least one processor to: build a runtime threat environment comprising a cloned version of the computer function of a computer function from the set of computer functions based on the set of threat objects; detect one or more threats by analyzing an execution of the cloned version of the computer function within the runtime threat environment; and generate a validated threat object indicating a confirmation of the threat data associated with the computer function.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media. Non-transitory computer-readable storage media (devices) includes RAM, ROM, EEPROM, solid state drives (“SSDs”) (e.g., based on RAM), Flash memory, phase-change memory (“PCM”), or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network computers, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 (e.g., the server device(s) 202 and/or the client device 210) that may be configured to perform one or more of the processes described above. One will appreciate that server device(s) 202 and/or the client device 210 may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 11 is a schematic diagram illustrating environment 1100 within which one or more implementations of the function threat detection system 200 can be implemented. For example, the function threat detection system 200 may be part of a generative AI system 100. Generative AI system 100 may generate, store, manage, receive, and send digital content (such as digital content items). For example, generative AI system 100 may send and receive digital content to and from client devices 1106 by way of network 1104. In particular, generative AI system 100 can store and manage a collection of digital content. Generative AI system 100 can manage the sharing of digital content between computing devices associated with a plurality of users. For instance, generative AI system 100 can facilitate a user sharing a digital content with another user of generative AI system 100.

In particular, generative AI system 100 can manage synchronizing digital content across multiple client devices 1106 associated with one or more users. For example, a user may edit digital content using client device 1106. The generative AI system 100 can cause client device 1106 to send the edited digital content to generative AI system 100. Generative AI system 100 then synchronizes the edited digital content on one or more additional computing devices.

In addition to synchronizing digital content across multiple devices, one or more implementations of generative AI system 100 can provide an efficient storage option for users that have large collections of digital content. For example, generative AI system 100 can store a collection of digital content on generative AI system 100, while the client device 1106 only stores reduced-sized versions of the digital content. A user can navigate and browse the reduced-sized versions (e.g., a thumbnail of a digital image) of the digital content on client device 1106. In particular, one way in which a user can experience digital content is to browse the reduced-sized versions of the digital content on client device 1106.

Another way in which a user can experience digital content is to select a reduced-size version of digital content to request the full- or high-resolution version of digital content from generative AI system 100. In particular, upon a user selecting a reduced-sized version of digital content, client device 1106 sends a request to generative AI system 100 requesting the digital content associated with the reduced-sized version of the digital content. Generative AI system 100 can respond to the request by sending the digital content to client device 1106. Client device 1106, upon receiving the digital content, can then present the digital content to the user. In this way, a user can have access to large collections of digital content while minimizing the amount of resources used on client device 1106.

Client device 1106 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access generative AI system 100.

As illustrated, the generative AI system 100 communicates with third-party system(s) 1108 by way of the network 1104. For example, the generative AI system 100 generates computer code or scripts for execution by the third-party system(s) 1108 as part of generating an output. In some cases, the generative AI system 100 integrates subcomponents or features of the third-party system(s) 1108 using APIs or other integrations. The third-party system(s) 1108 can include systems housed and operated on servers separate from the generative AI system 100, such as data management systems, calendaring systems, social networking systems, search engine systems, and/or computer other systems.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
retrieving, utilizing a code indexing subroutine, a computer function from a function repository of a computer application;
determining a vulnerability ranking for the computer function based on a call graph defining relationships among computer functions of the computer application;
generating, utilizing a large language model of a generative artificial intelligence (AI) system, a threat model comprising a structured data object defining threat parameters corresponding to the computer application; and
generating, based on the vulnerability ranking and by utilizing a large language model to analyze the computer function together with the threat model, a threat object indicating threat data associated with the computer function.

2. The computer-implemented method of claim 1, wherein utilizing the code indexing subroutine comprises scanning the function repository utilizing a large language model to identify the computer function.

3. The computer-implemented method of claim 1, wherein generating the threat model comprises utilizing the large language model to define the threat parameters of the computer application comprising at least one of a relevant attack surface of the computer application, a relevant vulnerability class of the computer application, or a threat prioritization criteria of the threat model.

4. The computer-implemented method of claim 1, wherein generating the call graph further comprises:
generating, utilizing the large language model, a data structure defining relationships between the computer function and other computer functions of the computer application.

5. The computer-implemented method of claim 1, further comprising:
generating the threat object by utilizing the large language model and the threat model in an isolated container, wherein the isolated container controls access of the large language model.

6. The computer-implemented method of claim 1, further comprising:
building a runtime threat environment comprising a cloned version of the computer function based on the threat object; and
generating, utilizing the large language model within the runtime threat environment, a validated threat object indicating a confirmation of the threat data associated with the computer function based on analyzing an execution of the cloned version of the computer function within the runtime threat environment.

7. The computer-implemented method of claim 1, further comprising:
receiving, from an external environment source, external threat data outlining one or more vulnerabilities associated with the computer application; and
generating the threat model based on informing the large language model with the external threat data.

8. A system comprising:
at least one processor; and
a non-transitory computer-readable medium storing instructions which, when executed by the at least one processor, cause the system to:
retrieve, utilizing a code indexing subroutine, a computer function from a function repository of a computer application;
determine a vulnerability ranking for the computer function based on a call graph defining relationships among computer functions of the computer application, wherein the vulnerability ranking involves determining a vulnerability score indicating an initial severity of a vulnerability associated with the computer function;
generate, utilizing a large language model of a generative artificial intelligence (AI) system, a threat model comprising a structured data object defining threat parameters corresponding to the computer application; and
generate, based on the vulnerability ranking and by utilizing a large language model to analyze the computer function together with the threat model, a threat object indicating threat data associated with the computer function.

9. The system of claim 8, further comprising instructions which, when executed by the at least one processor, cause the system to discover the computer function by scanning the function repository utilizing a large language model according to a code window.

10. The system of claim 8, further comprising instructions which, when executed by the at least one processor, cause the system to:
identify the threat parameters corresponding to at least one of relevant attack surfaces, relevant vulnerability classes, or threat prioritization criteria of the threat model;
receive one or more user inputs modifying at least one of the relevant attack surfaces, the relevant vulnerability classes, or the threat prioritization criteria of the threat model; and
update the threat parameters based on the one or more user inputs.

11. The system of claim 8, further comprising instructions which, when executed by the at least one processor, cause the system to:
annotate function calls among the computer functions with taint attributes based on at least one of data sources, sinks, or data flows of the function calls; and
determine the vulnerability ranking for the computer function based on annotating the function calls.

12. The system of claim 8, further comprising instructions which, when executed by the at least one processor, cause the system to generate the threat object by utilizing the large language model and the threat model in an isolated container, wherein the isolated container defines a boundary between the large language model and a control plane.

13. The system of claim 8, further comprising instructions which, when executed by the at least one processor, cause the system to:
generate an isolated container comprising a validation agent;
build, within the isolated container, a runtime threat environment comprising a cloned version of the computer function associated with the threat object; and
validate the threat object by analyzing, utilizing the validation agent, an execution of the cloned version of the computer function within the runtime threat environment by indicating a confirmation of the threat data associated with the computer function.

14. The system of claim 8, further comprising instructions which, when executed by the at least one processor, cause the system to:
provide for display within a graphical user interface the threat object, wherein the threat object comprises a threat summary;
receive from a client device, via an input field, within the graphical user interface, one or more user inputs requesting additional threat information about the threat object; and
generate, utilizing a large language model, a response comprising the additional threat information.

15. A non-transitory computer-readable medium storing executable instructions which, when executed by at least one processor, cause the at least one processor to:
retrieve, utilizing a code indexing subroutine, a set of computer functions from a function repository of a computer application;
determine a set of vulnerability rankings for the set of computer functions based on a call graph defining relationships among computer functions of the computer application;
generate, utilizing a large language model of a generative artificial intelligence (AI) system, a threat model comprising a structured data object defining threat parameters corresponding to the computer application; and
generate, based on the set of vulnerability rankings and by utilizing a large language model to analyze the set of computer functions together with the threat model, a set of threat objects indicating threat data associated with the set of computer functions.

16. The non-transitory computer-readable medium of claim 15, wherein utilizing the code indexing subroutine comprises discovering the set of computer functions by scanning the function repository utilizing metadata tags.

17. The non-transitory computer-readable medium of claim 15, further storing instructions which, when executed by the at least one processor, cause the at least one processor to:
indirectly coordinate a reading and writing of one or more shared objects by one or more large language model agents on a content-addressable store utilizing one or more stigmergic agentic algorithms.

18. The non-transitory computer-readable medium of claim 15, further storing instructions which, when executed by the at least one processor, cause the at least one processor to:
annotate function calls among the computer functions with security-relevant metadata; and
determine the set of vulnerability rankings for the set of computer functions based on annotating the function calls.

19. The non-transitory computer-readable medium of claim 15, further storing instructions which, when executed by the at least one processor, cause the at least one processor to:
generate the set of threat objects by utilizing the large language model and the threat model in an isolated capability-gated container, wherein the isolated capability-gated container defines a boundary between the large language model and a control plane.

20. The non-transitory computer-readable medium of claim 15, further storing instructions which, when executed by the at least one processor, cause the at least one processor to:
build a runtime threat environment comprising a cloned version of a computer function from the set of computer functions based on the set of threat objects;
detect one or more threats by analyzing an execution of the cloned version of the computer function within the runtime threat environment; and
generate a validated threat object indicating a confirmation of the threat data associated with the computer function.
